(19) United States
(12) Patent Application Publication
(10) Pub. No.: US 2026/0371210 A1
(43) Pub. Date: Nov. 19, 2026

(54) METHODS AND APPARATUSES FOR SUPPORTING COEXISTENCE OF DIFFERENT TYPES OF MOBILITY

(71) Applicant: LENOVO (BEIJING) LIMITED, Beijing (CN)

(72) Inventors: Congchi ZHANG, Shanghai (CN); Prateek BASU MALLICK, Dreieich (DE); Lianhai WU, Beijing (CN); Mingzeng DAI, Shanghai (CN); Joachim LÖHR, Wiesbaden (DE); Shuigen YANG, Shanghai (CN)

(21) Appl. No.: 19/145,656

(22) PCT Filed: Jan. 6, 2023
(86) PCT No.: PCT/CN2023/071002

§ 371 Date: Jul. 3, 2025

(51) Int. Cl. H04W 36/32; H04W 36/00

(52) U.S. Cl. CPC H04W 36/32; H04W 36/00835

(57) ABSTRACT

Embodiments of the present disclosure relate to methods and apparatuses for supporting coexistence of different types of mobility. According to some embodiments of the disclosure, a user equipment (UE) may include: a transceiver; and a processor coupled to the transceiver and configured to: receive, via the transceiver, first configuration information related to lower layer triggered mobility (LTM) operation or secondary cell group (SCG) selective activation (SCGSA) operation; receive, via the transceiver, second configuration information related to a layer 3 (L3) cell switch; determine whether to apply the second configuration information to perform the L3 cell switch; and in response to determining to apply the second configuration information to perform the L3 cell switch, apply the second configuration information based on the first configuration information to perform the L3 cell switch.

### TECHNICAL FIELD

Embodiments of the present application generally relate to wireless communication technologies, and more particularly to methods and apparatuses for supporting coexistence of different types of mobility.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Different types of mobility may be supported in a wireless communication system. However, detailed procedures and signaling enhancements between network nodes to support coexistence of different types of mobility have not been discussed yet.

### SUMMARY OF THE APPLICATION

Embodiments of the present application provide technical solutions at least for supporting coexistence of different types of mobility.

According to some embodiments of the present application, a user equipment (UE) may include: a transceiver; and a processor coupled to the transceiver and configured to: receive, via the transceiver, first configuration information related to lower layer triggered mobility (LTM) operation or secondary cell group (SCG) selective activation (SCGSA) operation; receive, via the transceiver, second configuration information related to a layer 3 (L3) cell switch; determine whether to apply the second configuration information to perform the L3 cell switch; and in response to determining to apply the second configuration information to perform the L3 cell switch, apply the second configuration information based on the first configuration information to perform the L3 cell switch.

In some embodiments of the present application, the first configuration information is associated with a reference configuration related to the LTM operation or the SCGSA operation, the second configuration information includes a delta configuration on top of the reference configuration, and to apply the second configuration information based on the first configuration information to perform the L3 cell switch, the processor is configured to: apply the delta configuration based on the reference configuration to perform the L3 cell switch regardless of which cell the UE is currently connected to.

In some embodiments of the present application, the first configuration information includes a set of configurations related to the LTM operation or the SCGSA operation, each of the set of configurations is associated with a respective candidate cell within a set of candidate cells including a current cell the UE is connected to, the second configuration information includes a delta configuration on top of a configuration within the set of configurations that is associated with the current cell, and to apply the second configuration information based on the first configuration information to perform the L3 cell switch, the processor is configured to: apply the delta configuration based on the configuration associated with the current cell to perform the L3 cell switch.

In some embodiments of the present application, the first configuration information is associated with a reference configuration and includes a set of configurations related to the LTM operation or the SCGSA operation, each of the set of configurations is associated with a respective candidate cell within a set of candidate cells including a target cell of the L3 cell switch, each of the set of configurations is a corresponding first delta configuration associated with the respective candidate cell, or is the reference configuration, the second configuration information includes a second delta configuration on top of at least one of the reference configuration or a first delta configuration within the set of configurations that is associated with the target cell, and to apply the second configuration information based on the first configuration information to perform the L3 cell switch, the processor is configured to: apply the second delta configuration based on the at least one of the reference configuration or the first delta configuration associated with the target cell to perform the L3 cell switch to the target cell.

In some embodiments of the present application, the first configuration information is associated with a reference configuration and includes a set of configurations related to the LTM operation, each of the set of configurations is associated with a respective candidate cell within a set of candidate cells, each of the set of configurations is a corresponding first delta configuration associated with the respective candidate cell, or is the reference configuration, the second configuration information is a message indicating the UE to perform the L3 cell switch to a candidate cell within the set of candidate cells, and to apply the second configuration information based on the first configuration information to perform the L3 cell switch, the processor is configured to: apply at least one of the reference configuration or a first delta configuration within the set of configurations that is associated with the candidate cell to perform the L3 cell switch to the candidate cell.

In some embodiments of the present application, the second configuration information includes an identity (ID) of the candidate cell.

In some embodiments of the present application, the reference configuration is a configuration associated with a cell to which the UE is connected when it receives the first configuration information, or is a configuration different from configuration(s) of all candidate cell(s) related to the LTM operation or the SCGSA operation, or is a configuration associated with a candidate cell related to the LTM operation or the SCGSA operation.

In some embodiments of the present application, the processor is further configured to determine not to apply the second configuration information to perform the L3 cell switch in at least one of the following cases: the UE has switched to a cell according to an LTM command or according to a conditional configuration related to the SCGSA operation within a time period, and the cell is different from a target cell of the L3 cell switch indicated by the second configuration information; or a source cell of the L3 cell switch indicated by the second configuration information is different from a cell to which the UE is currently connected.

In some embodiments of the present application, the processor is further configured to transmit, via the transceiver to a network node, an indication indicating not applying the second configuration information.

In some embodiments of the present application, the indication includes a cause value indicating a wrong source cell.

According to some embodiments of the present application, a first network node may include: a transceiver; and a processor coupled to the transceiver and configured to: determine to trigger an L3 cell switch for a UE; and transmit, via the transceiver, configuration information related to the L3 cell switch to a second network node or to the UE.

In some embodiments of the present application, the processor is further configured to: transmit, via the transceiver, a first message to a third network node, wherein the first message includes a reference configuration related to the LTM operation or the SCGSA operation; and receive, via the transceiver, a second message responsive to the first message from the third network node, wherein the second message includes a delta configuration on top of the reference configuration; and the configuration information includes the delta configuration.

In some embodiments of the present application, the processor is further configured to: transmit, via the transceiver, one or more first messages to a third network node, wherein the one or more first messages include a set of configurations related to the LTM operation or the SCGSA operation, and each of the set of configurations is associated with a respective candidate cell within a set of candidate cells; and receive, via the transceiver, one or more second messages responsive to the one or more first messages from the third network node, wherein the one or more second messages include a set of delta configurations, and each delta configuration within the set of delta configurations is associated with a respective candidate cell within the set of candidate cells and generated based on a configuration within the set of configurations that is associated with the respective candidate cell.

In some embodiments of the present application, the processor is further configured to: determine a current cell to which the UE is connected, wherein the current cell is within the set of candidate cells and the configuration information includes a delta configuration within the set of delta configurations which is associated with the current cell.

In some embodiments of the present application, the processor is further configured to: determine a target cell of the L3 cell switch, wherein the target cell is within a set of candidate cells related to the LTM operation or the SCGSA operation, wherein each candidate cell within the set of candidate cells is associated with a corresponding first delta configuration, or is a reference configuration related to the LTM operation or the SCGSA operation, and wherein the configuration information includes a second delta configuration on top of at least one of the reference configuration or a first delta configuration associated with the target cell.

In some embodiments of the present application, the processor is further configured to: determine a target cell of the L3 cell switch, wherein the target cell is within a set of candidate cells related to the LTM operation, and wherein the configuration information is a message requesting the second network node to trigger an LTM operation to switch the UE to the target cell.

In some embodiments of the present application, the configuration information includes an ID of the target cell.

In some embodiments of the present application, the reference configuration is a configuration associated with a cell to which the UE is connected when it receives configuration(s) of candidate cell(s) related to the LTM operation or the SCGSA operation, or is a configuration different from configuration(s) of all candidate cell(s) related to the LTM operation or the SCGSA operation, or is a configuration associated with a candidate cell related to the LTM operation or the SCGSA operation.

In some embodiments of the present application, the processor is further configured to receive, via the transceiver from the UE, an indication indicating not applying the configuration information.

In some embodiments of the present application, the indication includes a cause value indicating a wrong source cell.

According to some embodiments of the present application, a method performed by a UE may include: receiving first configuration information related to LTM operation or SCGSA operation; receiving second configuration information related to an L3 cell switch; determining whether to apply the second configuration information to perform the L3 cell switch; and in response to determining to apply the second configuration information to perform the L3 cell switch, applying the second configuration information based on the first configuration information to perform the L3 cell switch.

According to some embodiments of the present application, a method performed by a first network node may include: determining to trigger an L3 cell switch for a UE; and transmitting configuration information related to the L3 cell switch to a second network node or to the UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application.

FIG. 2 illustrates a flowchart of an exemplary inter-gNB handover procedure according to some embodiments of the present application.

FIG. 3 illustrates a flowchart of an exemplary intra-gNB-CU, inter-gNB-DU mobility procedure according to some embodiments of the present application.

FIG. 4 illustrates a flowchart of an exemplary method for triggering LTM and L3 cell switch according to some embodiments of the present application.

FIG. 5 illustrates a flowchart of an exemplary method for triggering SCGSA and L3 cell switch according to some embodiments of the present application.

FIG. 6 illustrates a flowchart of an exemplary method for supporting coexistence of LTM and inter-CU L3 primary cell (PCell) switch according to some embodiments of the present application.

FIG. 7 illustrates a flowchart of an exemplary method for supporting coexistence of LTM and inter-CU L3 PCell switch according to some other embodiments of the present application.

FIG. 8 illustrates an example of a second delta configuration related to L3 cell switch according to some embodiments of the present application.

FIG. 9 illustrates a flowchart of an exemplary method for supporting coexistence of SCGSA and inter-SN L3 primary secondary cell (PSCell) switch according to some embodiments of the present application.

FIG. 10 illustrates a flowchart of an exemplary method for supporting coexistence of SCGSA and inter-SN L3 PSCell switch according to some other embodiments of the present application.

FIG. 11 illustrates an example of a second delta configuration related to L3 cell switch according to some other embodiments of the present application.

FIG. 12 illustrates a simplified block diagram of an exemplary apparatus for supporting coexistence of LTM/SCGSA and L3 cell switch according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 101a and the UE 101b in the embodiments of FIG. 1 are in a coverage area of the BS 102, and may transmit information or data to the BS 102 and receive control information or data from the BS 102, for example, via LTE or NR Uu interface. In other embodiments, one or more of the UE 101a and the UE 101b may be outside of the coverage area of the BS 102.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. The BS 102 is generally a part of a radio access network that may include one or more controllers communicably coupled to the BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein the BS(s) 102 may transmit data using an orthogonal frequency division multiplexing (OFDM) modulation scheme on the downlink (DL) and the UE(s) 101 may transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS(s) 102 may communicate using other communication protocols, such as the IEEE 802.11 family of wireless communication protocols. Further, in some embodiments of the present disclosure, the BS(s) 102 may communicate over licensed spectrums, whereas in other embodiments, the BS(s) 102 may communicate over unlicensed spectrums. The present disclosure is not intended to be limited to the implementation of any particular wireless communication system architecture or protocol. In yet some embodiments of the present disclosure, the BS(s) 102 may communicate with the UE(s) 101 using the 3GPP 5G protocols.

In the wireless communication system 100, various types of mobility of UE(s) 101 may be supported. The following embodiments provide several exemplary types of mobility of a UE.

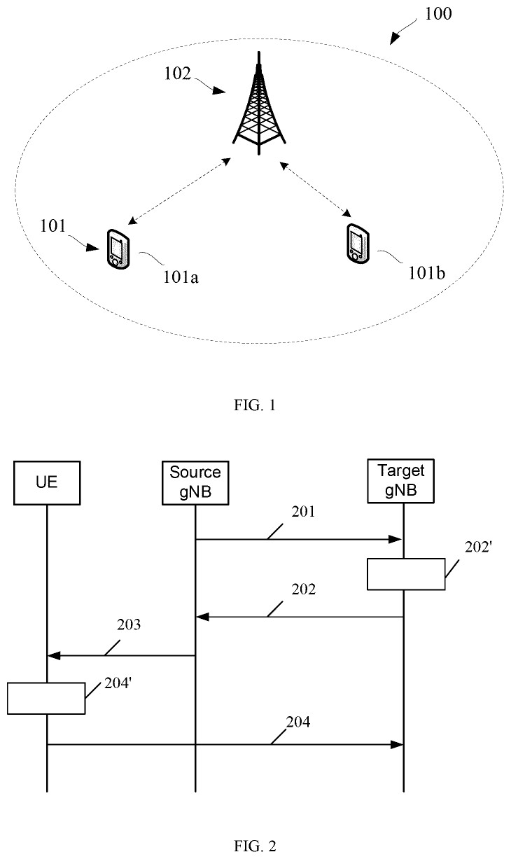

FIG. 2 illustrates an exemplary inter-gNB handover procedure according to some embodiments of the present application, in which a UE performs a cell switch from a source cell of a source gNB to a target cell of a target gNB. The procedure illustrated in FIG. 2 may be used for inter-gNB cell level mobility.

Referring to FIG. 2, in step 201, the source gNB may initiate a handover and issue a handover request message (e.g., HANDOVER REQUEST as specified in 3GPP standard documents) over an Xn interface to the target gNB.

In step 202′, the target gNB may perform admission control.

In step 202, the target gNB may provide a new radio resource control (RRC) configuration as part of a handover request acknowledge message (e.g., HANDOVER REQUEST ACKNOWLEDGE as specified in 3GPP standard documents), and transmit the handover request acknowledge message to the source gNB.

In step 203, the source gNB may provide the RRC configuration to the UE by forwarding an RRC reconfiguration message (e.g., RRCReconfiguration as specified in 3GPP standard documents) received in the handover request acknowledge message. The RRC reconfiguration message may include at least a cell ID and all information required to access the target cell, so that the UE can access the target cell without reading system information. For some cases, the information required for contention-based and contention-free random access can be included in the RRC reconfiguration message. The information required to access the target cell may include beam specific information, if any.

In step 204′, the UE may move an RRC connection to the target gNB.

In step 204, the UE may reply to the target gNB with an RRC reconfiguration complete message (e.g., RRCReconfigurationComplete as specified in 3GPP standard documents).

According to some embodiments of the present application, the internal structure of a BS (e.g., gNB) may be divided into a centralized unit (CU) and at least one distributed unit (DU). The CU and the at least one DU are connected with each other by an Fl interface as specified in 3GPP standard documents. The RRC layer functionality, service data adaptation protocol (SDAP) functionality, and packet data convergence protocol (PDCP) layer functionality are included in the CU. The radio link control (RLC) layer functionality, medium access control (MAC) layer functionality, and physical (PHY) layer functionality are included in each DU.

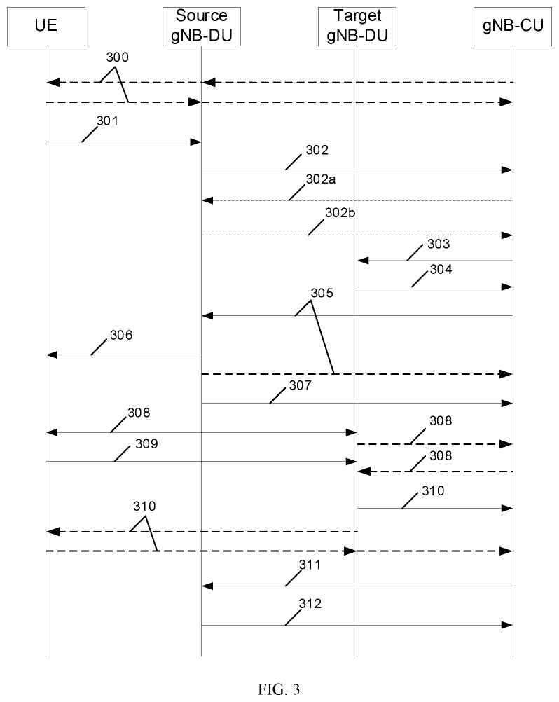

FIG. 3 illustrates an exemplary intra-gNB-CU, inter-gNB-DU mobility procedure according to some embodiments of the present application. The procedure in FIG. 3 may be used for the case when a UE moves from a source gNB-DU to a target gNB-DU within the same gNB-CU.

Referring to FIG. 3, in step 300, UL packets are sent from the UE, and are forwarded to the gNB-CU through the source gNB-DU; and DL packets are sent from the gNB-CU, and are forwarded to the UE through the source gNB-DU.

In step 301, the UE may send a measurement report message (e.g., MeasurementReport as specified in 3GPP standard documents) to the source gNB-DU.

In step 302, the source gNB-DU may send a UL RRC message transfer message (e.g., UL RRC MESSAGE TRANSFER as specified in 3GPP standard documents) to the gNB-CU to convey the received measurement report message.

In step 302a, the gNB-CU may send a UE context modification request message (e.g., UE CONTEXT MODIFICATION REQUEST as specified in 3GPP standard documents) to the source gNB-DU to query the latest configuration. In step 302b, the source gNB-DU may respond to the gNB-CU with a UE context modification response message (e.g., UE CONTEXT MODIFICATION RESPONSE as specified in 3GPP standard documents) that includes full configuration information. Steps 302a and 302b may be optional.

In step 303, the gNB-CU may send a UE context setup request message (e.g., UE CONTEXT SETUP REQUEST as specified in 3GPP standard documents) to the target gNB-DU to create a UE context and set up one or more data bearers. The UE CONTEXT SETUP REQUEST message may include handover preparation information (e.g., HandoverPreparationInformation as specified in 3GPP standard documents).

In step 304, the target gNB-DU may respond to the gNB-CU with a UE context setup response message (e.g., UE CONTEXT SETUP RESPONSE as specified in 3GPP standard documents).

In step 305, the gNB-CU may send a UE context modification request message (e.g., UE CONTEXT MODIFICATION REQUEST as specified in 3GPP standard documents) to the source gNB-DU, which includes a generated RRC reconfiguration message (e.g., RRCReconfiguration as specified in 3GPP standard documents) and indicates to stop the data transmission for the UE. The source gNB-DU may send a DL data delivery status frame (e.g., Downlink Data Delivery Status as specified in 3GPP standard documents) to inform the gNB-CU about the unsuccessfully transmitted DL data to the UE, if any.

In step 306, the source gNB-DU may forward the received RRC reconfiguration message to the UE.

In step 307, the source gNB-DU may respond to the gNB-CU with a UE context modification response message (e.g., UE CONTEXT MODIFICATION RESPONSE as specified in 3GPP standard documents).

In step 308, a random access procedure may be performed at the target gNB-DU. The target gNB-DU may optionally send a DL data delivery status frame (e.g., Downlink Data Delivery Status as specified in 3GPP standard documents) to inform the gNB-CU. DL packets, which may include PDCP protocol data units (PDUs) not successfully transmitted in the source gNB-DU, if any, are sent from the gNB-CU to the target gNB-DU.

In step 309, the UE may respond to the target gNB-DU with an RRC reconfiguration complete message (e.g., RRCReconfigurationComplete as specified in 3GPP standard documents).

In step 310, the target gNB-DU may send a UL RRC message transfer message (e.g., UL RRC MESSAGE TRANSFER as specified in 3GPP standard documents) to the gNB-CU to convey the received RRC reconfiguration complete message. Then, DL packets are sent to the UE. Also, UL packets are sent from the UE, which are forwarded to the gNB-CU through the target gNB-DU.

In step 311, the gNB-CU may send a UE context release message (e.g., UE CONTEXT RELEASE COMMAND as specified in 3GPP standard documents) to the source gNB-DU.

In step 312, the source gNB-DU may release the UE context and respond to the gNB-CU with a UE context release complete message (e.g., UE CONTEXT RELEASE COMPLETE as specified in 3GPP standard documents).

In addition to the above procedures, in 3GPP Release 18, inter cell LTM may be supported. The LMT operation may involve the following operations.
A UE may be provided with configurations of multiple candidate cells (e.g., special cells (SpCells)) or multiple candidate cell groups before receiving an LTM command from a DU of a BS (e.g., gNB-DU). A SpCell may be a PCell or a PSCell. A cell group may be a master cell group (MCG) or a SCG.
When the DU of the BS triggers the LTM operation based on received layer 1 (L1) measurement result(s), the DU of the BS may send an LTM command to the UE, e.g., via a MAC control element (CE) or DL control information (DCI).
The DU of the BS also informs a CU of the BS about either the trigger of the LTM operation or the successful execution of the LTM operation. For example, the trigger of the LTM operation may mean that the DU of the BS has sent the LTM command to the UE; and the successful execution of the LTM operation may mean that the UE has switched to the target cell indicated by the LTM command successfully.
The UE does not release the configurations of multiple candidate cells or multiple candidate cell groups after executing the LTM operation triggered by the DU of the BS.

Different from LTM, an L3 cell (e.g., PCell/PSCell) change (or switch) may be triggered by a CU of a BS (e.g., gNB-CU) based on the received L3 measurement result(s). Assuming that the LTM has been configured (e.g., multiple candidate cells or cell groups have been configured or prepared at both a UE and a DU) and an LTM operation may be triggered by the DU at any time, it is possible that a CU may start preparing or triggering an L3 cell switch based on received L3 measurement result(s) without being aware of an LTM operation already triggered by the DU. In such cases, a delta configuration prepared for the L3 cell switch may be outdated with a wrong source cell assumed by the CU.

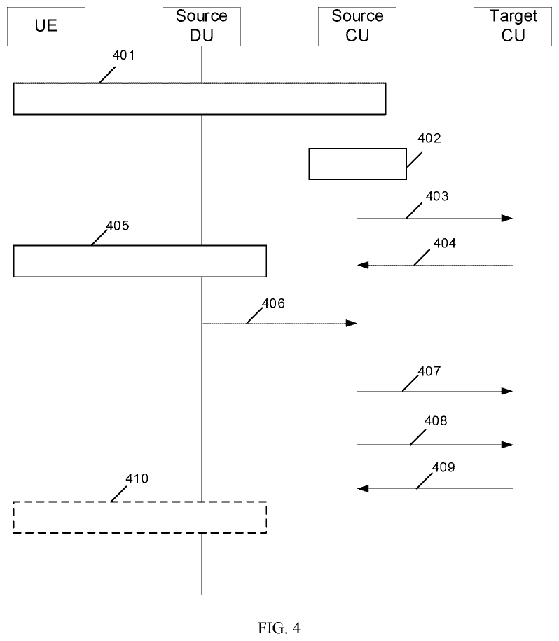

FIG. 4 illustrates an exemplary method for triggering LTM and L3 cell switch according to some embodiments of the present application.

Referring to FIG. 4, a UE is initially connected to a source cell (e.g., cell 1). In operation 401, LTM may be configured to the UE. In operation 402, a source CU may determine to trigger an L3 cell switch for the UE to a target CU based on received L3 measurement results. In operation 403, the source CU may transmit a handover request message as stated above over an Xn interface to the target CU. In response to the handover request message, the target CU may generate a delta configuration based on the assumed source cell of the UE, i.e., cell 1, and then transmit the delta configuration to the source CU in operation 404.

However, after operation 403, a source DU may trigger an LTM operation based on received L1 measurement results and handover the UE from cell 1 to a new cell (e.g., cell 2) in operation 405. In operation 406, the source DU may inform the source CU about the trigger of the LTM operation. Operation 406 may occur before, after, or simultaneously with operation 404, and occur before the source CU transmits the delta configuration to the UE.

In such cases, the delta configuration prepared by the target CU is no longer valid, because the currently connected source cell of the UE becomes cell 2 while the delta configuration is generated based on cell 1. To resolve the collision between LTM and L3 cell switch, the following solutions may be adopted.

One solution is that the source CU may cancel an already initiated handover request and reinitiates another handover request with the updated source cell. For example, as shown in FIG. 4, in operation 407, the source CU may transmit an indication to the target CU to cancel the already initiated handover request (i.e., the handover request associated with the handover request message transmitted in operation 403). In operation 408, the source CU may transmit an updated handover request message with the updated source cell (i.e., cell 2) to the target CU. In response to receiving the updated handover request message, the target CU may generate an updated delta configuration based on cell 2 and transmit the updated delta configuration to the source CU in operation 409. Obviously, canceling and reinitiating the L3 cell switch due to LTM will introduce additional handover delays. In some cases, another LTM operation may be triggered in operation 410, and thus operations 407-409 may be performed again, which may further increase the handover delay.

Another solution is that the source CU de-configures the LTM at the UE before it triggers an L3 cell switch (or change). However, such solution requires additional RRC reconfiguration signaling over Uu interface and also introduces additional handover delays.

Given the above, new solutions are needed to resolve the aforementioned issues in the coexistence between LTM and L3 cell switch.

In addition to LTM, SCGSA may also be supported in a wireless communication network. The SCGSA operation may involve the following operations.
A UE is configured with candidate PSCells each is associated with an execution condition. For example, the execution condition may be included in a conditional configuration associated with a candidate PSCell. For example, an execution condition may be that the link quality of a candidate PSCell is more than a threshold better than the link quality of a source PSCell.
When an execution condition associated with a candidate PSCell is met, e.g., the link quality of this candidate PSCell is more than a threshold better than the source PSCell, the UE may perform a conditional PSCell change or PSCell addition procedure towards this candidate PSCell.
After finishing the conditional PSCell change or addition procedure, the UE may not release conditional configurations of other candidate PSCells for subsequent conditional PSCell changes, and the UE continues evaluating the execution conditions of other candidate PScells.
When an execution condition associated with another candidate PScell is met, the UE may perform a conditional PSCell change towards the another candidate PSCell.

In some cases, assuming that the SCGSA has been configured for the UE, it is possible that a master node (MN) or a secondary node (SN) may start preparing or triggering an L3 cell (e.g., PSCell) switch (or change) based on received L3 measurement result(s) without being aware of an already executed SCGSA. In such cases, a delta configuration prepared for the L3 cell switch may be outdated with a wrong source cell assumed by the MN or SN.

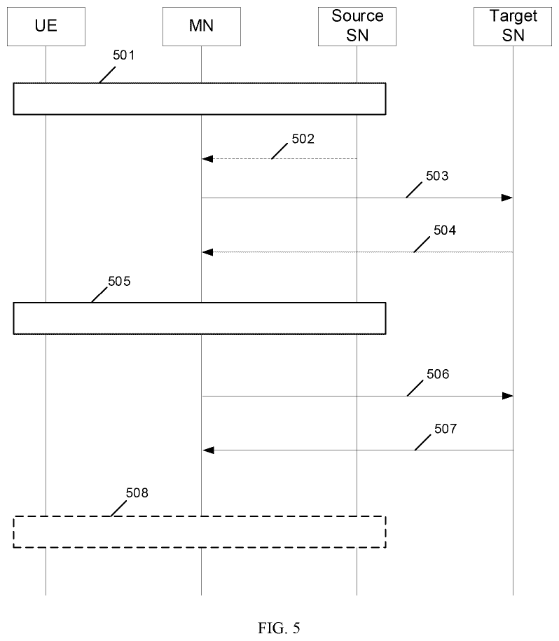

FIG. 5 illustrates an exemplary method for triggering SCGSA and L3 cell switch according to some embodiments of the present application.

Referring to FIG. 5, a UE is initially connected to a source cell (e.g., PSCell 1) of a source SN. In operation 501, SCGSA may be configured to the UE. In operation 502 (which is an optional operation), the source SN may transmit, to an MN, an SN change required message (e.g., SN Change Required as specified in 3GPP standard documents) indicating to change SN. In operation 503, the MN may determine to change the SN to a target SN and send an SN addition request message (e.g., SN Addition Request as specified in 3GPP standard documents) to the target SN over an Xn interface. In response to receiving the SN addition request message, the target SN may generate a PSCell change delta configuration based on the assumed source cell (i.e., PSCell 1), and transmit the PSCell change delta configuration to the MN via an SN addition acknowledge message (e.g., SN Addition Acknowledge as specified in 3GPP standard documents) in operation 504.

However, after operation 503, in operation 505, the UE may switch to a candidate PSCell (e.g., PSCell 2) based on SCGSA, e.g., in response to an execution condition associated with the candidate PSCell being met. Operation 505 may occur before, after, or simultaneously with operation 504, and occur before the MN transmits the PSCell change delta configuration to the UE.

In such cases, the delta configuration prepared by the target SN is no longer valid, because the currently connected source cell of the UE becomes PSCell 2 while the delta configuration is generated based on PSCell 1. To resolve the collision between SCGSA and L3 cell (e.g., PSCell) switch, the following solutions may be adopted.

One solution is that the MN or source SN provides the updated source PSCell or SCG configuration to the target SN. For example, as shown in FIG. 5, in operation 506, the MN may transmit an SN modification request message (e.g., SN Modification Request as specified in 3GPP standard documents) to the target SN to provide the updated source PSCell (i.e., PSCell 2) to the target SN. In response to receiving the SN modification request message, the target SN may generate an updated PSCell change delta configuration based on PSCell 2 and transmit the updated PSCell change delta configuration to the MN in operation 507. Obviously, reinitiating the L3 cell switch due to SCGSA will introduce additional handover delays. In some cases, in operation 508, the UE may switch to another candidate PSCell (e.g., PSCell 3) based on SCGSA, e.g., in response to an execution condition associated with the another candidate PSCell being met, and thus operations 506 and 507 may be performed again, which may further increase the handover delay.

Another solution is that the MN or the source SN de-configures the SCGSA at the UE before it triggers an L3 cell (e.g., PSCell) switch (or change). However, such solution requires additional RRC reconfiguration signaling over Uu interface and also introduces additional handover delays.

Given the above, new solutions are needed to resolve the aforementioned issues in the coexistence between SCGSA and L3 cell switch.

Given the above, embodiments of the present application propose solutions for supporting coexistence of different types of mobility. For example, embodiments of the present application propose detailed procedures and related signalings for supporting coexistence of LTM and L3 PCell or PSCell switch (or change). As another example, embodiments of the present application propose detailed procedures and related signalings for supporting coexistence of SCGSA and L3 PSCell switch (or change). The solutions in the embodiments of the present application can solve at least the above issues. More details on embodiments of the present application will be described in the following text in combination with the appended drawings.

Based on the different types of mobility, the coexistence scenarios may include the following two cases, i.e., case 1 and case 2.

### Case 1

In case 1, LTM and L3 cell switch (e.g., L3 PCell switch or PSCell switch) may be coexistent. The L3 cell switch in the embodiments of the subject application may also be referred to as L3 cell change. The following embodiments provide several solutions for supporting the coexistence of LTM and L3 cell switch.

### Embodiment 1

In embodiment 1, a UE may receive first configuration information (also referred to as LTM configuration) related to LTM operation. The first configuration information may be associated with a reference configuration related to the LTM operation. In some embodiments, the reference configuration may be a configuration associated with a cell to which the UE is connected when it receives the first configuration information. In some embodiments, the first configuration information may explicitly include the reference configuration. In some other embodiments, the first configuration information may implicitly indicate the reference configuration. For example, the first configuration information may indicate to use a specific configuration as the reference configuration without explicitly providing the specific configuration. The reference configuration may be stored on the UE. When a first network node, for example, a CU of a BS (e.g., a gNB-CU), prepares an L3 cell switch (which may be either intra-CU L3 cell switch or inter-CU L3 cell switch), it may generate a delta configuration on top of the reference configuration. Then, the generated delta configuration may be sent to the UE via an RRC message (e.g., which includes information element ReconfigurationWithSync). Then, the UE may apply the delta configuration based on (or on top of) the stored reference configuration to perform the L3 cell switch regardless of which cell the UE is currently connected to, i.e., irrespective of the current source cell at the time of receiving the delta configuration for L3 cell switch by the UE.

The technical solutions provided by embodiment 1 may apply to both intra-CU (or intra-BS) and inter-CU (or inter-BS) L3 cell switch scenarios.

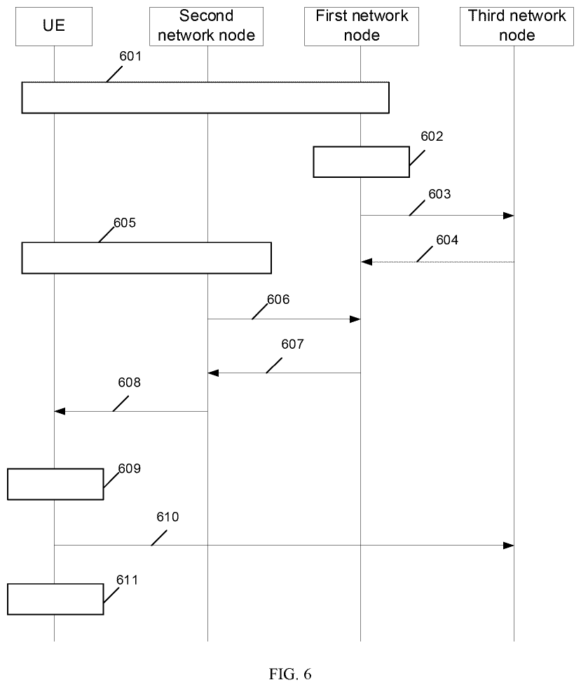

FIG. 6 illustrates an exemplary method for supporting coexistence of LTM and inter-CU L3 PCell switch according to some embodiments of the present application. The method illustrated in FIG. 6 may be performed by a UE and three network nodes (e.g., a first network node, a second network node, and a third network node). In some embodiments of the present application, the first network node may be a CU of a BS (e.g., source CU) or other apparatus with the like functions. The second network node may be a DU of the BS (e.g., source DU) or other apparatus with the like functions. The third network node may be a CU of another BS (e.g., target CU) or other apparatus with the like functions. Although the method is illustrated in a system level, persons skilled in the art can understand that the method implemented in the UE and the three network nodes can be separately implemented and incorporated in other apparatus with the like functions.

Referring to FIG. 6, the UE is initially connected to a source cell (e.g., cell 1). In operation 601, LTM may be configured to the UE. For example, the UE may receive first configuration information related to LTM operation (e.g., for LTM) in operation 601. The first configuration information may be associated with a reference configuration related to LTM operation.

In some embodiments, the reference configuration may be a configuration associated with a cell to which the UE is connected when it receives the first configuration information. In such embodiments, the first configuration information may include a set of delta configurations related to the LTM operation, and each of the set of delta configurations is associated with a respective candidate cell within a set of candidate cells related to the LTM operation and is generated based on (or on top of) the reference configuration. A set of elements in the embodiments of the subject application may refer to one or more elements. A candidate cell may be a SPCell, e.g., a PCell or a PSCell.

In some embodiments, the reference configuration may be a configuration different from configuration(s) of all candidate cell(s) related to the LTM operation. In such embodiments, the first configuration information may include the reference configuration and a set of delta configurations related to the LTM operation, and each of the set of delta configurations is associated with a respective candidate cell within a set of candidate cells related to the LTM operation and is generated based on (or on top of) the reference configuration.

In some embodiments, the reference configuration may be a configuration of a candidate cell related to the LTM operation. In such embodiments, the first configuration information may include a set of configurations related to the LTM operation, and each of the set of configurations is associated with a respective candidate cell within a set of candidate cells related to the LTM operation. The first configuration information may indicate which configuration in the set of the configurations is the reference configuration. In such embodiments, the other configurations in the set of configurations may be delta configurations generated based on (or on top of) the reference configuration.

In operation 602, the first network node may determine to trigger an L3 cell switch for the UE to a target cell (e.g., cell 3) based on L3 measurement results, wherein cell 3 belongs to the third network node.

In operation 603, the first network node may transmit a first message (e.g., a handover request message) to the third network node, e.g., over an Xn interface. The first message may include the reference configuration.

In response to the first message, the third network node may generate a delta configuration for the L3 cell switch on top of (or based on) the reference configuration. Then, in operation 604, the third network node may transmit a second message (e.g., handover request acknowledge message) including the delta configuration to the first network node, e.g., over an Xn interface.

After operation 603, in operation 605, the second network node may trigger an LTM operation based on received L1 measurement results and handover the UE from cell 1 to a new cell (e.g., cell 2). In operation 606, the second network node may inform the first network node about the trigger of the LTM operation.

In operation 607, the first network node may transmit, to the second network node, second configuration information related to the L3 cell switch, e.g., over an F1 interface. The second configuration information may include the delta configuration generated by the third network node. For example, the second configuration information may be included in a UE context modification request message.

In operation 608, the second network node may transmit, to the UE, the second configuration information. For example, the second configuration information may be included in an RRC message with information element ReconfigurationWithSync (e.g., an RRC reconfiguration message) transmitted from the second network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, in operation 609, the UE may apply the second configuration information based on (or on top of) the first configuration information to perform the L3 cell switch. For example, the UE may apply the delta configuration included in the second configuration information based on (or on top of) the reference configuration to perform the L3 cell switch regardless of which cell the UE is currently connected to. For example, the UE may initiate a random access channel (RACH) procedure to cell 3 as instructed by the delta configuration.

In response to successfully performing the RACH procedure, the UE may transmit an RRC complete message to the third network node (i.e., to cell 3) in operation 610.

In operation 611, the UE may release all configurations related to LTM operation after executing the L3 cell switch.

Although FIG. 6 shows an L3 PCell switch as an example, similar operations may also apply to an L3 PSCell switch. For inter-CU L3 PSCell switch, the difference lies in that the first message transmitted in operation 603 may be an SN addition request message and the second message transmitted in operation 604 may be an SN addition request acknowledge message.

### Embodiment 2

In embodiment 2, a UE may receive first configuration information (also referred to as LTM configuration) related to LTM operation. The first configuration information may include a set of configurations related to the LTM operation, and each of the set of configurations is associated with a respective candidate cell (PCell or PSCell) within a set of candidate cells related to the LTM operation.

In embodiment 2, when a first network node (e.g., a source CU) triggers an inter-CU L3 cell switch, the first network node may transmit one or more first messages to a third network node (e.g., a target CU), wherein the one or more first messages may include the set of configurations related to the LTM operation.

As one example, the first network node may transmit one first message including all of the set of configurations. As another example, the first network node may transmit multiple first messages and each first message of the multiple first messages may include a respective configuration within the set of configurations.

The third network node may transmit one or more second messages responsive to the one or more first messages to the first network node. The one or more second messages may include a set of delta configurations, and each delta configuration within the set of delta configurations is associated with a respective candidate cell within the set of candidate cells and generated based on (or on top of) a configuration within the set of configurations that is associated with the respective candidate cell.

As one example, the third network node may transmit one second message including all of the set of delta configurations. As another example, the third network node may transmit multiple second messages and each second message of the multiple second messages includes a respective delta configuration within the set of delta configurations.

In some examples, the inter-CU L3 cell switch may be an inter-CU L3 PCell switch. In such examples, the set of candidate cells may be a set of candidate PCells, and the set of configurations may be a set of configurations associated with the set of candidate PCells. In such example, the first message may be a handover request message and the second message may be a handover request acknowledge message.

In some other examples, the inter-CU L3 cell switch may be an inter-CU L3 PSCell switch. In such examples, the set of candidate cells may be a set of candidate PSCells, and the set of configurations may be a set of configurations associated with the set of candidate PSCells. In such example, the first message may be an SN addition request message and the second message may be an SN addition request acknowledge message.

After receiving the set of delta configurations, it is upon the first network node to determine which delta configuration may be sent to the UE according to the currently connected source cell of the UE. For example, after receiving the set of delta configurations, the first network node may determine a current cell to which the UE is connected, wherein the current cell may be within the set of candidate cells. Then, the first network node may transmit second configuration information including a delta configuration within the set of delta configurations which is associated with the current cell. Then, the UE may apply the delta configuration based on (or on top of) a configuration associated with the current cell to perform the L3 cell switch.

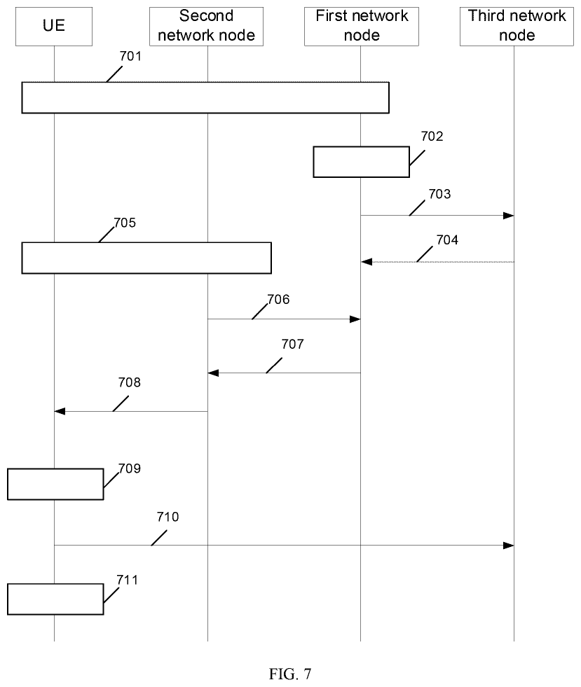

FIG. 7 illustrates an exemplary method for supporting coexistence of LTM and inter-CU L3 PCell switch according to some embodiments of the present application. The method illustrated in FIG. 7 may be performed by a UE and three network nodes (e.g., a first network node, a second network node, and a third network node). In some embodiments of the present application, the first network node may be a CU of a BS (e.g., source CU) or other apparatus with the like functions. The second network node may be a DU of the BS (e.g., source DU) or other apparatus with the like functions. The third network node may be a CU of another BS (e.g., target CU) or other apparatus with the like functions. Although the method is illustrated in a system level, persons skilled in the art can understand that the method implemented in the UE and the three network nodes can be separately implemented and incorporated in other apparatus with the like functions.

Referring to FIG. 7, the UE is initially connected to a source cell (e.g., cell 1). In operation 701, LTM may be configured to the UE. For example, the UE may receive first configuration information in operation 701. The definitions regarding the first configuration information as provided in the preceding contents of embodiment 2 may apply here.

In operation 702, the first network node may determine to trigger an L3 cell switch for the UE to a target cell (e.g., cell 3) based on L3 measurement results, wherein cell 3 belongs to the third network node.

In operation 703, the first network node may transmit a first message (e.g., handover request message) including a set of configurations to the third network node, e.g., over an Xn interface. Each of the set of configurations may be associated with a respective candidate cell (e.g., PCell) within a set of candidate cells (e.g., PCells) related to the LTM operation.

In response to the first message, the third network node may generate a set of delta configurations, and each delta configuration within the set of delta configurations is associated with a respective candidate cell within the set of candidate cells and generated based on (or on top of) a configuration within the set of configurations that is associated with the respective candidate cell.

Then, in operation 704, the third network node may transmit a second message (e.g., handover request acknowledge message) including the set of delta configurations to the first network node, e.g., over an Xn interface. For example, the set of delta configurations may include {DeltaConfig1 by assuming cell #1 as the source cell, DeltaConfig2 by assuming cell #2 as the source cell, . . . , DeltaConfigN by assuming cell #N as the source cell}, wherein N is the number of candidate cells included in the set of candidate cells.

After operation 703, in operation 705, the second network node may trigger an LTM operation based on received L1 measurement results and handover the UE from cell 1 to a new cell (e.g., cell 2). In operation 706, the second network node may inform the first network node about the trigger of the LTM operation.

The first network node may determine a current cell (e.g., cell 2) to which the UE is connected, wherein cell 2 is within the set of candidate cells. Then, in operation 707, the first network node may transmit, to the second network node, second configuration information, e.g., over an Fl interface, and the second configuration information may include the delta configuration within the set of delta configurations which is associated with cell 2 and generated based on (or on top of) a configuration associated with cell 2. For example, the second configuration information may be included in a UE context modification request message.

In operation 708, the second network node may transmit, to the UE, the second configuration information. For example, the second configuration information may be included in an RRC message with information element ReconfigurationWithSync (e.g., RRC reconfiguration message) transmitted from the second network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, in operation 709, the UE may apply the second configuration information based on the first configuration information to perform the L3 cell switch. For example, the UE may apply the delta configuration included in the second configuration information based on (or on top of) a configuration associated with cell 2 (the configuration associated with cell 2 may be included in the first configuration information) to perform the L3 cell switch to cell 3. For example, the UE may initiate a RACH procedure to cell 3 as instructed by the delta configuration.

In response to successfully performing the RACH procedure, the UE may transmit an RRC complete message to the third network node (i.e., to cell 3) in operation 710.

In operation 711, the UE may release all configurations related to LTM operation after executing the L3 cell switch.

### Embodiment 3

In embodiment 3, a UE may receive first configuration information (also referred to as LTM configuration) related to LTM operation. The first configuration information may be associated with a reference configuration related to LTM operation, and includes a set of configurations related to the LTM operation. Each of the set of configurations is associated with a respective candidate cell within a set of candidate cells, and each of the set of configurations may be a corresponding first delta configuration associated with the respective candidate cell, or may be the reference configuration.

As an example, the reference configuration may be a configuration associated with a cell to which the UE is connected when it receives the first configuration information. In such example, each of the set of configurations included in the first configuration information may be a corresponding first delta configuration associated with a respective candidate cell (e.g., a PCell or a PSCell) within the set of candidate cells and is generated based on (or on top of) the reference configuration.

As another example, the reference configuration may be a configuration different from configuration(s) of all candidate cell(s) related to the LTM operation. In such example, the first configuration information may include both the reference configuration and the set of configurations, and each of the set of configurations may be a corresponding first delta configuration associated with a respective candidate cell (e.g., a PCell or a PSCell) within the set of candidate cells and is generated based on (or on top of) the reference configuration.

As yet another example, the reference configuration may be a configuration of a candidate cell related to the LTM operation. In such example, each of the set of configurations included in the first configuration information is associated with a respective candidate cell (e.g., a PCell or a PSCell) within a set of candidate cells related to the LTM operation. The first configuration information may indicate which configuration in the set of configurations is the reference configuration. Each of the other configurations in the set of configurations may be a corresponding first delta configuration associated with a respective candidate cell and generated based on (or on top of) the reference configuration.

In embodiment 3, a first network node (e.g., a CU) may determine to trigger an L3 cell switch for the UE based on L3 measurement results. The first network node may determine that a target cell of the L3 cell switch is within the set of candidate cells related to the LTM operation. Embodiment 3 may further include embodiment 3-1 and embodiment 3-2.

### Embodiment 3-1

In embodiment 3-1, the first network node may generate a second delta configuration on top of at least one of the reference configuration or a first delta configuration within the set of configurations that is associated with the target cell.

For example, in the case that the target cell is associated with a first delta configuration, the first network node may generate the second delta configuration on top of the reference configuration and the first delta configuration associated with the target cell. As another example, in the case that the target cell is a candidate cell whose configuration is indicated as the reference configuration, the first network node may generate the second delta configuration on top of the reference configuration.

Then, the first network node may transmit second configuration information including the second delta configuration to a second network node (e.g., a DU of the BS), e.g., over an F1 interface. For example, the second configuration information may be included in a UE context modification request message.

Then, the second network node may transmit, to the UE, the second configuration information. For example, the second configuration information may be included in an RRC message with information element ReconfigurationWithSync (e.g., RRC reconfiguration message) transmitted from the second network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, the UE may apply the second configuration information based on the first configuration information to perform the L3 cell switch. For example, the UE may apply the second delta configuration based on (or on top of) at least one of the reference configuration or the first delta configuration associated with the target cell to perform the L3 cell switch to the target cell.

As an example, in the case that the target cell is associated with a first delta configuration, the UE may apply the second delta configuration based on (or on top of) the reference configuration and the first delta configuration associated with the target cell. As an example, in the case that the target cell is a candidate cell whose configuration is indicated as the reference configuration, the UE may apply the second delta configuration based on (or on top of) the reference configuration.

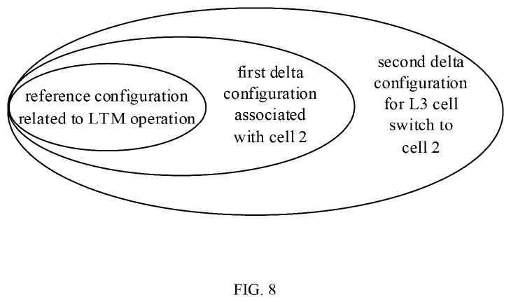

FIG. 8 illustrates an example of a second delta configuration related to L3 cell switch according to some embodiments of the present application.

In the example of FIG. 8, it is assumed that the UE has been configured with two candidate cells (e.g., cell 1 and cell 2) related to the LTM operation (or for LTM). The first configuration information received by the UE may include a reference configuration related to the LTM operation (or for LTM) and a corresponding first delta configuration associated with cell 1 and a corresponding first delta configuration associated with cell 2 related to the LTM operation. The UE is currently connected to Cell 1. When a CU of a BS (e.g., gNB-CU) determines to trigger an L3 cell switch for the UE to handover the UE from cell 1 to cell 2, the CU may provide the second delta configuration for L3 cell switch to cell 2 as shown in FIG. 8 which is on top of {the reference configuration related to LTM operation+the first delta configuration associated with cell 2}. In this way, the signaling overhead over F1 interface and Uu interface for L3 cell switch may be reduced. The UE applies the received second delta configuration to perform L3 cell switch to cell 2 in the manner of {the reference configuration related to LTM operation+the first delta configuration associated with cell 2+the second delta configuration for L3 cell switch to cell 2}.

### Embodiment 3-2

In embodiment 3-2, the first network node (e.g., a CU) may determine that the configuration related to LTM operation associated with the target cell (which is a candidate cell within the set of candidate cells related to LTM operation) can be reused. Then, the first network node may not generate a second delta configuration as stated above.

In some examples of embodiment 3-2, the first network node may transmit second configuration information to the second network node (e.g., a DU of the BS) requesting the second network node to trigger an L3 cell switch for the UE to the target cell. The second configuration information may be transmitted over an F1 interface. For example, the second configuration may include an ID of the target cell. For example, the second configuration information may be included in a UE context modification request message.

Then, the second network node may transmit the second configuration information to the UE indicating the UE to perform the L3 cell switch to the target cell After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, the UE may apply the second configuration information based on the first configuration information to perform the L3 cell switch. For example, the UE may apply at least one of the reference configuration or a first delta configuration within the set of configurations that is associated with the target cell to perform the L3 cell switch to the target cell.

As an example, in the case that the target cell is associated with a first delta configuration within the set of configurations, the UE may apply the first delta configuration associated with the target cell based on (or on top of) the reference configuration to perform the L3 cell switch to the target cell. As an example, in the case that a configuration of the target cell is indicated as the reference configuration, the UE may apply the reference configuration to perform the L3 cell switch to the target cell.

In some other examples, the first network node may transmit second configuration information to the second network node (e.g., a DU of the BS) requesting the second network node to trigger an LTM operation to switch the UE to the target cell. The second configuration information may be transmitted over an F1 interface. For example, the second configuration may include an ID of the target cell. For example, the second configuration information may be included in a UE context modification request message. For example, the second configuration information may be an LTM request at least includes the ID of the target cell.

Then, the second network node may transmit an LTM command via MAC CE or DCI to indicate the UE to perform an LTM operation to the target cell.

After receiving the LTM command, the UE may perform an LTM operation to switch from a source cell to the target cell.

### Embodiment 4

In embodiment 4, a UE may receive first configuration information related to LTM operation. For example, the first configuration information may include configurations of a set of candidate cells related to the LTM operation. As another example, the first configuration information may be associated with a reference configuration and includes a set of delta configurations, and each of the set of delta configurations may be associated with a respective candidate cell within a set of candidate cells related to the LTM operation. The reference configuration may be a configuration associated with a cell to which the UE is connected when it receives the first configuration information, or is a configuration different from configuration(s) of all candidate cell(s) related to the LTM operation, or a configuration of a candidate cell related to the LTM operation. All the definitions regarding the first configuration information related to LTM operation provided to the UE in embodiments 1-3 may apply here.

The UE may also receive second configuration information related to an L3 cell switch to a target cell.

The UE may determine whether to apply the second configuration information to perform the L3 cell switch. For example, the UE may determine not to apply the second configuration information to perform the L3 cell switch in at least one of the following cases:
The UE has switched to a cell (e.g., PCell or PSCell) according to an LTM command within a time period, and the cell is different from a target cell (e.g., PCell or PSCell) of the L3 cell switch indicated by the second configuration information. For example, the time period may be a fixed value, e.g., 1000 ms, or may be a value configured by the network.
A source cell (e.g., PCell or PSCell) of the L3 cell switch indicated by the second configuration information is different from a cell (e.g., PCell or PSCell) to which the UE is currently connected.

In some embodiments, the UE may transmit, to a first network node (e.g., a source CU of a BS) or a second network node (e.g., a DU of the BS), an indication indicating not applying the second configuration information or indicating an ignorance of the second configuration information. For example, the indication may be an RRC message. For example, the indication may include a new cause value indicating a wrong source cell.

It is contemplated that persons skilled in the art would anticipate solutions similar to those described with respect to case 1 may be applicable in the case that a candidate cell is replaced with a candidate cell group (e.g., a candidate MCG or SCG), and a (delta) configuration associated with a candidate cell is replaced with a (delta) configuration associated with a candidate cell group.

### Case 2

In case 2, SCGSA and L3 cell switch (e.g., L3 PSCell switch) may be coexistent. The following embodiments provide several solutions for supporting the coexistence of SCGSA and L3 cell switch.

### Embodiment 1′

In embodiment 1′, a UE may receive first configuration information (also referred to as SCGSA configuration) related to SCGSA operation. The first configuration information may be associated with a reference configuration related to the SCGSA operation. In some embodiments, the first configuration information may explicitly include the reference configuration. In some other embodiments, the first configuration information may implicitly indicate the reference configuration. For example, the first configuration information may indicate to use a specific configuration as the reference configuration without explicitly providing the specific configuration. The reference configuration may be stored on the UE. When an MN or an SN prepares an L3 cell switch (which may be either intra-SN L3 cell switch or inter-SN L3 cell switch), it may generate a delta configuration on top of the reference configuration. Then, the generated delta configuration may be sent to the UE via an RRC message (e.g., which includes information element Reconfiguration WithSync). Then, the UE may apply the delta configuration based on (or on top of) the stored reference configuration to perform the L3 cell switch regardless of which cell the UE is currently connected to, i.e., irrespective of the current source cell at the time of receiving the delta configuration for L3 cell switch by the UE.

The technical solutions provided by embodiment 1 may apply to both intra-SN and inter-SN L3 cell switch scenarios.

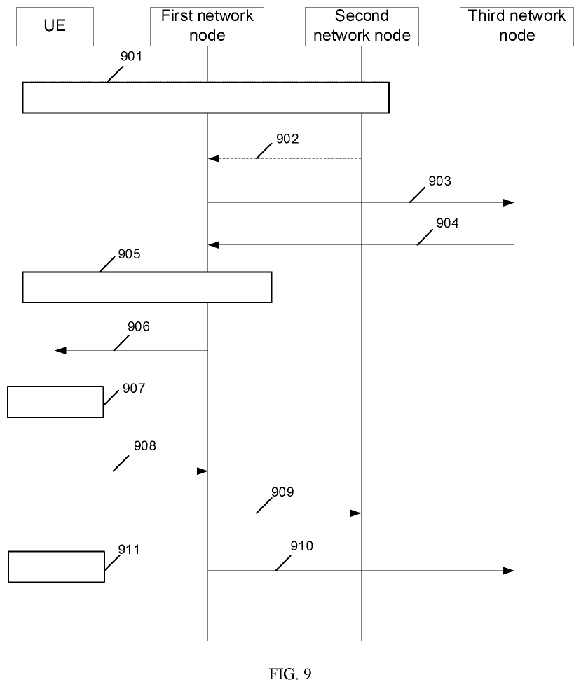

FIG. 9 illustrates an exemplary method for supporting coexistence of SCGSA and inter-SN L3 PSCell switch according to some embodiments of the present application. The method illustrated in FIG. 9 may be performed by a UE and three network nodes (e.g., a first network node, a second network node, and a third network node). In some embodiments of the present application, the first network node may be an MN or other apparatus with the like functions. The second network node may be a source SN or other apparatus with the like functions. The third network node may be a target SN or other apparatus with the like functions. Although the method is illustrated in a system level, persons skilled in the art can understand that the method implemented in the UE and the three network nodes can be separately implemented and incorporated in other apparatus with the like functions.

Referring to FIG. 9, the UE is initially connected to a source cell (e.g., cell 1). In operation 901, SCGSA may be configured to the UE. For example, the UE may receive first configuration information related to SCGSA operation (e.g., for SCGSA) in operation 901. The first configuration information may be associated with a reference configuration related to SCGSA operation.

In some embodiments, the reference configuration may be a configuration associated with a cell to which the UE is connected when it receives the first configuration information. In such embodiments, the first configuration information may include a set of delta configurations related to the SCGSA operation, and each of the set of delta configurations is associated with a respective candidate cell within a set of candidate cells related to the SCGSA operation and is generated based on (or on top of) the reference configuration. A candidate cell may be a PSCell.

In some embodiments, the reference configuration may be a configuration different from configuration(s) of all candidate cell(s) related to the SCGSA operation. In such embodiments, the first configuration information may include the reference configuration and a set of delta configurations related to the SCGSA operation, and each of the set of delta configurations is associated with a respective candidate cell within a set of candidate cells related to the SCGSA operation and is generated based on (or on top of) the reference configuration.

In some embodiments, the reference configuration may be a configuration of a candidate cell related to the SCGSA operation. In such embodiments, the first configuration information may include a set of configurations related to the SCGSA operation, and each of the set of configurations is associated with a respective candidate cell within a set of candidate cells related to the SCGSA operation. The first configuration information may indicate which configuration in the set of the configurations is the reference configuration. In such embodiments, the other configurations in the set of configurations may be delta configurations generated based on (or on top of) the reference configuration.

The first network node or the second network node may determine to trigger an L3 cell switch for the UE to a target cell (e.g., cell 3) based on L3 measurement results, wherein cell 3 belongs to the third network node.

For example, in operation 902 (which is an optional operation and may be performed in the case that the second network node determines to trigger the L3 switch, and may not be performed in the case that the first network node determines to trigger the L3 switch), the second network node may transmit to the first network node a message (e.g., an SN change required message) indicating to change SN.

In operation 903, the first network node may transmit a first message (e.g., an SN addition request message) to the third network node, e.g., over an Xn interface. The first message may include the reference configuration.

In response to the first message, the third network node may generate a delta configuration for the L3 cell switch on top of (or based on) the reference configuration. Then, in operation 904, the third network node may transmit a second message (e.g., SN addition request acknowledge message) including the delta configuration to the first network node, e.g., over an Xn interface.

After operation 903, in operation 905, the UE may switch to a candidate cell (e.g., cell 2) based on the SCGSA configuration, e.g., in response to an execution condition associated with the candidate cell being met.

In operation 906, the first network node may transmit, to the UE, second configuration information related to the L3 cell switch. The second configuration information may include the delta configuration generated by the third network node. For example, the second configuration information may be included in an RRC message with information element ReconfigurationWithSync (e.g., an RRC reconfiguration message) transmitted from the first network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, in operation 907, the UE may apply the second configuration information based on (or on top of) the first configuration information to perform the L3 cell switch. For example, the UE may apply the delta configuration included in the second configuration information based on (or on top of) the reference configuration to perform the L3 cell switch regardless of which cell the UE is currently connected to. For example, the UE may initiate a RACH procedure to cell 3 as instructed by the delta configuration.

In response to successfully performing the RACH procedure, the UE may transmit an RRC complete message to the first network node in operation 908.

In operation 909 (which is an optional operation and may be performed in the case that the second network node determines to trigger the L3 switch, and may not be performed in the case that the first network node determines to trigger the L3 switch), the first network node may transmit an SN change confirm message to the second network node.

In operation 910, the first network node may transmit an SN reconfiguration complete message to the third network node.

In operation 911, the UE may release all configurations related to SCGSA operation after executing the L3 cell switch.

### Embodiment 2′

In embodiment 2′, a UE may receive first configuration information (also referred to as SCGSA configuration) related to SCGSA operation. The first configuration information may include a set of configurations related to the SCGSA operation, and each of the set of configurations is associated with a respective candidate cell (e.g., PSCell) within a set of candidate cells (e.g., PSCells) related to the SCGSA operation.

In embodiment 2′, when a first network node (e.g., an MN) or a second network node (e.g., a source SN) triggers an inter-SN L3 PSCell switch, the first network node may transmit one or more first messages to a third network node (e.g., a target SN), wherein the one or more first messages may include the set of configurations related to the SCGSA operation.

As one example, the first network node may transmit one first message including all of the set of configurations. As another example, the first network node may transmit multiple first messages and each first message of the multiple first messages may include a respective configuration within the set of configurations. For example, the first message may be an SN addition request message.

The third network node may transmit one or more second messages responsive to the one or more first messages to the first network node. The one or more second messages may include a set of delta configurations, and each delta configuration within the set of delta configurations is associated with a respective candidate cell within the set of candidate cells and generated based on (or on top of) a configuration within the set of configurations that is associated with the respective candidate cell.

As one example, the third network node may transmit one second message including all of the set of delta configurations. As another example, the third network node may transmit multiple second messages and each second message of the multiple second messages includes a respective delta configuration within the set of delta configurations. For example, the second message may be an SN addition request acknowledge message.

After receiving the set of delta configurations, it is upon the first network node to determine which delta configuration may be sent to UE according to the currently connected source cell of the UE. For example, after receiving the set of delta configurations, the first network node may determine a current cell to which the UE is connected, wherein the current cell may be within the set of candidate cells. Then, the first network node may transmit second configuration information including a delta configuration within the set of delta configurations which is associated with the current cell. Then, the UE may apply the delta configuration based on (or on top of) a configuration associated with the current cell to perform the L3 cell switch.

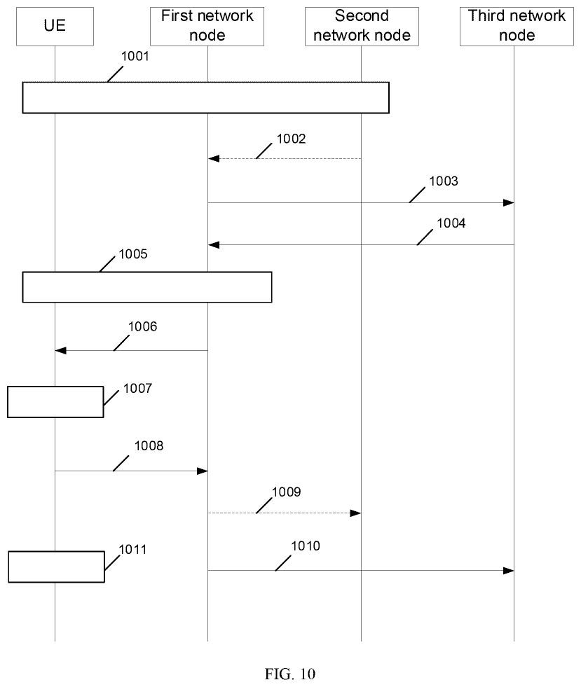

FIG. 10 illustrates an exemplary method for supporting coexistence of SCGSA and inter-SN L3 PSCell switch according to some embodiments of the present application. The method illustrated in FIG. 10 may be performed by a UE and three network nodes (e.g., a first network node, a second network node, and a third network node). In some embodiments of the present application, the first network node may be an MN or other apparatus with the like functions. The second network node may be a source SN or other apparatus with the like functions. The third network node may be a target SN or other apparatus with the like functions. Although the method is illustrated in a system level, persons skilled in the art can understand that the method implemented in the UE and the three network nodes can be separately implemented and incorporated in other apparatus with the like functions.

Referring to FIG. 10, the UE is initially connected to a source cell (e.g., cell 1). In operation 1001, SCGSA may be configured to a UE. For example, the UE may receive first configuration information in operation 1001. The definitions regarding the first configuration information as provided in the preceding contents of embodiment 2′ may apply here.

The first network node or the second network node may determine to trigger an L3 cell switch for the UE to a target cell (e.g., cell 3) based on L3 measurement results, wherein cell 3 belongs to the third network node.

For example, in operation 1002 (which is an optional operation and may be performed in the case that the second network node determines to trigger the L3 switch, and may not be performed in the case that the first network node determines to trigger the L3 switch), the second network node may transmit to the first network node a message (e.g., an SN change required message) indicating to change SN.

In operation 1003, the first network node may transmit a first message (e.g., SN addition request message) including the set of configurations to the third network node, e.g., over an Xn interface. Each of the set of configurations may be associated with a respective candidate cell (e.g., PSCell) within a set of candidate cells (e.g., PSCells) related to the SCGSA operation.

In response to the first message, the third network node may generate a set of delta configurations, and each delta configuration within the set of delta configurations is associated with a respective candidate cell within the set of candidate cells and generated based on (or on top of) a configuration within the set of configurations that is associated with the respective candidate cell.

Then, in operation 1004, the third network node may transmit a second message (e.g., SN addition request acknowledge message) including the set of delta configurations to the first network node, e.g., over an Xn interface. For example, the set of delta configurations may include {DeltaConfig1 by assuming cell #1 as the source cell, DeltaConfig2 by assuming cell #2 as the source cell, . . . , DeltaConfigN by assuming cell #N as the source cell}, wherein N is the number of candidate cells included in the set of candidate cells.

After operation 1003, in operation 1005, the UE may switch to a candidate cell (e.g., cell 2) based on the SCGSA configuration, e.g., in response to an execution condition associated with the candidate cell being met. The switching to cell 2 may be indicated to the first network node by the UE, and thus the first network node is aware that the UE is currently connected to cell 2.

The first network node may determine a current cell (e.g., cell 2) to which the UE is connected, wherein cell 2 is within the set of candidate cells. Then, in operation 1006, the first network node may transmit, to the UE, second configuration information including the delta configuration within the set of delta configurations which is associated with cell 2 and generated based on (or on top of) a configuration associated with cell 2. For example, the second configuration information may be included in an RRC message with information element ReconfigurationWithSync (e.g., RRC reconfiguration message) transmitted from the first network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, in operation 1007, the UE may apply the second configuration information based on the first configuration information to perform the L3 cell switch. For example, the UE may apply the delta configuration included in the second configuration information based on (or on top of) a configuration associated with cell 2 (the configuration associated with cell 2 may be included in the first configuration information) to perform the L3 cell switch to cell 3. For example, the UE may initiate a RACH procedure to cell 3 as instructed by the delta configuration.

After that, operations 1008-1011 may be performed. Operations 1008-1011 may be the same as operations 908-911, respectively.

### Embodiment 3′

In embodiment 3′, a UE may receive first configuration information (also referred to as SCGSA configuration) related to SCGSA operation. The first configuration information may be associated with a reference configuration related to SCGSA operation, and includes a set of configurations related to the SCGSA operation. Each of the set of configurations is associated with a respective candidate cell within a set of candidate cells, and each of the set of configurations may be a corresponding first delta configuration associated with the respective candidate cell, or may be the reference configuration.

As an example, the reference configuration may be a configuration associated with a cell to which the UE is connected when it receives the first configuration information. In such example, each of the set of configurations included in the first configuration information may be a corresponding first delta configuration associated with a respective candidate cell (e.g., a PSCell) within the set of candidate cells and is generated based on (or on top of) the reference configuration.

As another example, the reference configuration may be a configuration different from configuration(s) of all candidate cell(s) related to the SCGSA operation. In such example, the first configuration information may include both the reference configuration and the set of configurations, and each of the set of configurations may be a corresponding first delta configuration associated with a respective candidate cell (e.g., a PSCell) within the set of candidate cells and is generated based on (or on top of) the reference configuration.

As yet another example, the reference configuration may be a configuration of a candidate cell related to the SCGSA operation. In such example, each of the set of configurations included in the first configuration information is associated with a respective candidate cell (e.g., a PSCell) within a set of candidate cells related to the SCGSA operation. The first configuration information may indicate which configuration in the set of the configurations is the reference configuration. Each of the other configurations in the set of configurations may be a corresponding first delta configuration associated with a respective candidate cell and generated based on (or on top of) the reference configuration.

In embodiment 3′, a first network node (e.g., an MN) or a second network node (e.g., a source SN) may determine to trigger an L3 cell switch (e.g., L3 PSCell switch) for the UE based on L3 measurement results. The first network node may determine that a target cell of the L3 cell switch is within the set of candidate cells related to the SCGSA operation.

The first network node may generate a second delta configuration on top of at least one of the reference configuration or a first delta configuration within the set of configurations that is associated with the target cell.

For example, in the case that the target cell is associated with a first delta configuration, the first network node may generate the second delta configuration on top of the reference configuration and the first delta configuration associated with the target cell. As another example, in the case that the target cell is a candidate cell whose configuration is indicated as the reference configuration, the first network node may generate the second delta configuration on top of the reference configuration.

Then, the first network node may transmit second configuration information including the second delta configuration to the UE. For example, the second configuration information may be included in an RRC message with information element ReconfigurationWithSync (e.g., RRC reconfiguration message) transmitted from the first network node to the UE.

After receiving the second configuration information, the UE may determine whether to apply the second configuration information to perform the L3 cell switch. For example, the UE may parse the second configuration information to determine whether the second configuration information is for the L3 cell switch.

In response to determining to apply the second configuration information to perform the L3 cell switch, the UE may apply the second configuration information based on the first configuration information to perform the L3 cell switch. For example, UE may apply the second delta configuration based on (or on top of) at least one of the reference configuration or the first delta configuration associated with the target cell to perform the L3 cell switch to the target cell.

As an example, in the case that the target cell is associated with a first delta configuration, the UE may apply the second delta configuration based on (or on top of) the reference configuration and the first delta configuration associated with the target cell. As an example, in the case that the target cell is a candidate cell whose configuration is indicated as the reference configuration, the UE may apply the second delta configuration based on (or on top of) the reference configuration.

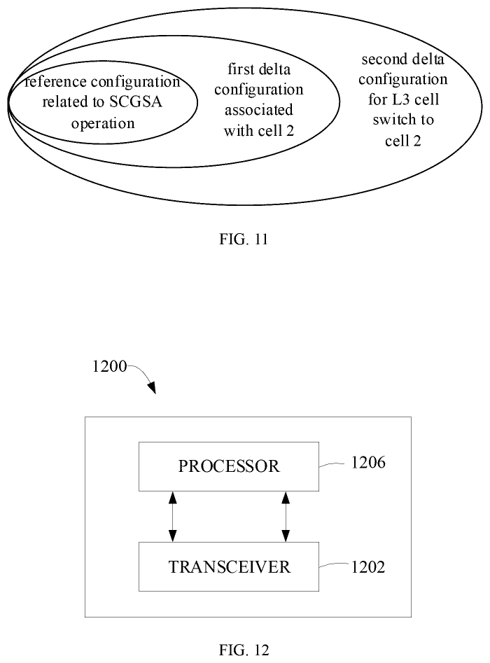

FIG. 11 illustrates an example of a second delta configuration related to L3 cell switch according to some embodiments of the present application.

In the example of FIG. 11, it is assumed that the UE has been configured with two candidate PSCells (e.g., cell 1 and cell 2) related to the SCGSA operation (or for SCGSA). The first configuration information received by the UE may include a reference configuration related to the SCGSA operation (or for SCGSA) and a corresponding first delta configuration associated with cell 1 and a corresponding first delta configuration associated with cell 2 related to the SCGSA operation. The UE is currently connected to cell 1. When an MN determines to trigger an L3 cell switch for the UE to handover the UE from cell 1 to cell 2, the MN may provide the second delta configuration for L3 cell switch to cell 2 as shown in FIG. 11 which is on top of {the reference configuration related to SCGSA operation+the first delta configuration associated with cell 2}. In this way, the signaling overhead over F1/Xn interface and Uu interface for L3 cell switch may be reduced. The UE applies the received second delta configuration to perform L3 cell switch to cell 2 in the manner of {the reference configuration related to SCGSA operation+the first delta configuration associated with cell 2+the second delta configuration for L3 cell switch to cell 2}.

### Embodiment 4′

In embodiment 4′, a UE may receive first configuration information related to SCGSA operation. For example, the first configuration information may include configurations of a set of candidate cells (e.g., PSCells) related to the SCGSA operation. As another example, the first configuration information may be associated with a reference configuration and includes a set of delta configurations, and each of the set of delta configurations may be associated with a respective candidate cell within a set of candidate cells (e.g., PSCells) related to the SCGSA operation. The reference configuration may be a configuration associated with a cell to which the UE is connected when it receives the first configuration information, or is a configuration different from configuration(s) of all candidate cell(s) related to the SCGSA operation, or a configuration of a candidate cell related to the SCGSA operation. All the definitions regarding the first configuration information related to SCGSA operation provided to the UE in embodiments 1′-3′ may apply here.

The UE may also receive second configuration information related to an L3 cell switch (e.g., L3 PSCell switch) to a target cell.

The UE may determine whether to apply the second configuration information to perform the L3 cell switch. For example, the UE may determine not to apply the second configuration information to perform the L3 cell switch in at least one of the following cases:
The UE has switched to a cell (e.g., PSCell) according to a conditional configuration related to the SCGSA operation within a time period, and the cell is different from a target cell (e.g., PSCell) of the L3 cell switch indicated by the second configuration information. For example, the time period may be a fixed value, e.g., 1000 ms, or may be a value configured by the network.
A source cell (e.g., PSCell) of the L3 cell switch indicated by the second configuration information is different from a cell (e.g., PSCell) to which the UE is currently connected.

In some embodiments, the UE may transmit, to the first network node (e.g., an MN) or the second network node (e.g., a source SN), an indication indicating not applying the second configuration information or indicating an ignorance of the second configuration information. For example, the indication may be an RRC message. For example, the indication may include a new cause value indicating a wrong source cell.

It is contemplated that persons skilled in the art would anticipate solutions similar to those described with respect to case 2 may be applicable in the case that a candidate cell is replaced with a candidate cell group (e.g., a candidate MCG or SCG), and a (delta) configuration associated with a candidate cell is replaced with a (delta) configuration associated with a candidate cell group.

FIG. 12 illustrates a simplified block diagram of an exemplary apparatus 1200 for supporting coexistence of LTM/SCGSA and L3 cell switch according to some embodiments of the present application. In some embodiments, the apparatus 1200 may be or include at least part of a UE (e.g., UE 101a or UE 101b in FIG. 1). In some other embodiments, the apparatus 1200 may be or include at least part of a first network node (e.g., a CU of a BS or an MN).

Referring to FIG. 12, the apparatus 1200 may include at least one transceiver 1202 and at least one processor 1206. The at least one transceiver 1202 is coupled to the at least one processor 1206.

Although in this figure, elements such as the transceiver 1202 and the processor 1206 are illustrated in the singular, the plural is contemplated unless a limitation to the singular is explicitly stated. In some embodiments of the present application, the transceiver 1202 may be divided into two devices, such as receiving circuitry (or a receiver) and transmitting circuitry (or a transmitter). In some embodiments of the present application, the apparatus 1200 may further include an input device, a memory, and/or other components. The transceiver 1202 and the processor 1206 may be configured to perform any of the methods described herein (e.g., the methods described with respect to FIGS. 2-11 or other methods described in the embodiments of the present application).

According to some embodiments of the present application, the apparatus 1200 may be a UE, and the transceiver 1202 and the processor 1206 may be configured to perform operations of the UE in any of the methods as described with respect to FIGS. 2-11 or other methods described in the embodiments of the present application. For example, the processor 1206 is configured to: receive, via the transceiver, first configuration information related to LTM operation or SCGSA operation; receive, via the transceiver, second configuration information related to an L3 cell switch; determine whether to apply the second configuration information to perform the L3 cell switch; and in response to determining to apply the second configuration information to perform the L3 cell switch, apply the second configuration information based on the first configuration information to perform the L3 cell switch.

According to some embodiments of the present application, the apparatus 1200 may be a first network node, and the transceiver 1202 and the processor 1206 may be configured to perform operations of the first network node in any of the methods as described with respect to FIGS. 2-11 or other methods described in the embodiments of the present application. For example, the processor 1206 is configured to: determine to trigger an L3 cell switch for a UE; and transmit, via the transceiver, configuration information related to the L3 cell switch to a second network node or to the UE.

In some embodiments of the present application, the apparatus 1200 may further include at least one non-transitory computer-readable medium. In some embodiments of the present disclosure, the non-transitory computer-readable medium may have stored thereon computer-executable instructions to cause the processor 1206 to implement any of the methods as described above. For example, the computer-executable instructions, when executed, may cause the processor 1206 to interact with the transceiver 1202, so as to perform operations of the methods, e.g., as described with respect to FIGS. 2-11 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for supporting coexistence of LTM/SCGSA and L3 cell switch, including a processor and a memory. Computer programmable instructions for implementing a method for supporting coexistence of LTM/SCGSA and L3 cell switch are stored in the memory, and the processor is configured to perform the computer programmable instructions to implement the method for supporting coexistence of LTM/SCGSA and L3 cell switch. The method for supporting coexistence of LTM/SCGSA and L3 cell switch may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for supporting coexistence of LTM/SCGSA and L3 cell switch according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive first configuration information related to a lower layer triggered mobility (LTM) operation or a secondary cell group (SCG) selective activation (SCGSA) operation;
receive second configuration information related to a layer 3 (L3) cell switch;
determine whether to apply the second configuration information to perform the L3 cell switch; and
apply the second configuration information based on the first configuration information to perform the L3 cell switch.

2. The UE of claim 1, wherein the first configuration information is associated with a reference configuration related to the LTM operation or the SCGSA operation, wherein the second configuration information includes a delta configuration on top of the reference configuration, and wherein the at least one processor is configured to cause the UE to apply the second configuration information based on the first configuration information to perform the L3 cell switch, by:
applying the delta configuration based on the reference configuration to perform the L3 cell switch regardless of which cell the UE is currently connected to.

3. The UE of claim 1, wherein the first configuration information includes a set of configurations related to the LTM operation or the SCGSA operation, wherein each of the set of configurations is associated with a respective candidate cell within a set of candidate cells including a current cell the UE is connected to, wherein the second configuration information includes a delta configuration on top of a configuration within the set of configurations that is associated with the current cell, and wherein the at least one processor is configured to cause the UE to apply the second configuration information based on the first configuration information to perform the L3 cell switch, by:
applying the delta configuration based on the configuration associated with the current cell to perform the L3 cell switch.

4. The UE of claim 1, wherein the first configuration information is associated with a reference configuration and includes a set of configurations related to the LTM operation or the SCGSA operation, wherein each of the set of configurations is associated with a respective candidate cell within a set of candidate cells including a target cell of the L3 cell switch, wherein each of the set of configurations is a corresponding first delta configuration associated with the respective candidate cell, or is the reference configuration, wherein the second configuration information includes a second delta configuration on top of at least one of the reference configuration or a first delta configuration within the set of configurations that is associated with the target cell, and wherein the at least one processor is configured to cause the UE to apply the second configuration information based on the first configuration information to perform the L3 cell switch, by:
applying the second delta configuration based on the at least one of the reference configuration or the first delta configuration associated with the target cell to perform the L3 cell switch to the target cell.

5. The UE of claim 1, wherein the first configuration information is associated with a reference configuration and includes a set of configurations related to the LTM operation, wherein each of the set of configurations is associated with a respective candidate cell within a set of candidate cells, wherein each of the set of configurations is a corresponding first delta configuration associated with the respective candidate cell, or is the reference configuration, wherein the second configuration information is a message indicating the UE to perform the L3 cell switch to a candidate cell within the set of candidate cells, and wherein the at least one processor is configured to cause the UE to apply the second configuration information based on the first configuration information to perform the L3 cell switch, by:
applying at least one of the reference configuration or a first delta configuration within the set of configurations that is associated with the candidate cell to perform the L3 cell switch to the candidate cell.

6. The UE of claim 5, wherein the second configuration information includes an identity (ID) of the candidate cell.

7. The UE of claim 2, wherein the reference configuration is a configuration associated with a cell to which the UE is connected when it receives the first configuration information, or is a configuration different from configurations of all candidate cells related to the LTM operation or the SCGSA operation, or is a configuration associated with a candidate cell related to the LTM operation or the SCGSA operation.

8. The UE of claim 1, wherein the at least one processor is further configured to cause the UE to determine not to apply the second configuration information to perform the L3 cell switch when:
the UE has switched to a cell according to an LTM command or according to a conditional configuration related to the SCGSA operation within a time period, and the cell is different from a target cell of the L3 cell switch indicated by the second configuration information; or
a source cell of the L3 cell switch indicated by the second configuration information is different from a cell to which the UE is currently connected.

9. The UE of claim 8, wherein the at least one processor is further configured to cause the UE to transmit, to a network node, an indication indicating the UE did not apply the second configuration information.

10. The UE of claim 9, wherein the indication includes a cause value indicating a wrong source cell.

11. A first network node for wireless communication, comprising:
at least one memory; and
at least one processor coupled with the at least one memory and configured to cause the first network node to:
determine to trigger a layer 3 (L3) cell switch for a user equipment (UE); and
transmit configuration information related to the L3 cell switch to a second network node or to the UE.

12. The first network node of claim 11, wherein the at least one processor is further configured to cause the first network node to:
transmit a first message to a third network node, wherein the first message includes a reference configuration related to a lower layer triggered mobility (LTM) operation or a secondary cell group (SCG) selective activation (SCGSA) operation; and
receive a second message responsive to the first message from the third network node, wherein the second message includes a delta configuration on top of the reference configuration;
wherein the configuration information includes the delta configuration.

13. The first network node of claim 11, wherein the at least one processor is further configured to cause the first network node to:
transmit one or more first messages to a third network node, wherein the one or more first messages include a set of configurations related to a lower layer triggered mobility (LTM) operation or a secondary cell group (SCG) selective activation (SCGSA) operation, and wherein each of the set of configurations is associated with a respective candidate cell within a set of candidate cells; and
receive one or more second messages responsive to the one or more first messages from the third network node, wherein the one or more second messages include a set of delta configurations, and each delta configuration within the set of delta configurations is associated with a respective candidate cell within the set of candidate cells and generated based on a configuration within the set of configurations that is associated with the respective candidate cell.

14. The first network node of claim 11, wherein the at least one processor is further configured to cause the first network node to:
determine a target cell of the L3 cell switch, wherein the target cell is within a set of candidate cells related to a lower layer triggered mobility (LTM) operation;
wherein the configuration information is a message requesting the second network node to trigger the LTM operation to switch the UE to the target cell.

15. A method performed by a user equipment (UE), the method comprising:
receiving first configuration information related to a lower layer triggered mobility (LTM) operation or a secondary cell group (SCG) selective activation (SCGSA) operation;
receiving second configuration information related to a layer 3 (L3) cell switch;
determining whether to apply the second configuration information to perform the L3 cell switch; and
applying the second configuration information based on the first configuration information to perform the L3 cell switch.

16. The method of claim 15, wherein the first configuration information is associated with a reference configuration related to the LTM operation or the SCGSA operation, wherein the second configuration information includes a delta configuration on top of the reference configuration, and wherein applying the second configuration information based on the first configuration information to perform the L3 cell switch includes:
applying the delta configuration based on the reference configuration to perform the L3 cell switch regardless of which cell the UE is currently connected to.

17. The method of claim 15, wherein the first configuration information includes a set of configurations related to the LTM operation or the SCGSA operation, wherein each of the set of configurations is associated with a respective candidate cell within a set of candidate cells including a current cell the UE is connected to, wherein the second configuration information includes a delta configuration on top of a configuration within the set of configurations that is associated with the current cell, and wherein applying the second configuration information based on the first configuration information to perform the L3 cell switch comprises:
applying the delta configuration based on the configuration associated with the current cell to perform the L3 cell switch.

18. The method of claim 15, wherein the first configuration information is associated with a reference configuration and includes a set of configurations related to the LTM operation or the SCGSA operation, wherein each of the set of configurations is associated with a respective candidate cell within a set of candidate cells including a target cell of the L3 cell switch, wherein each of the set of configurations is a corresponding first delta configuration associated with the respective candidate cell, or is the reference configuration, wherein the second configuration information includes a second delta configuration on top of at least one of the reference configuration or a first delta configuration within the set of configurations that is associated with the target cell, and wherein applying the second configuration information based on the first configuration information to perform the L3 cell switch includes:
applying the second delta configuration based on the at least one of the reference configuration or the first delta configuration associated with the target cell to perform the L3 cell switch to the target cell.

19. The method of claim 15, wherein the first configuration information is associated with a reference configuration and includes a set of configurations related to the LTM operation, wherein each of the set of configurations is associated with a respective candidate cell within a set of candidate cells, wherein each of the set of configurations is a corresponding first delta configuration associated with the respective candidate cell, or is the reference configuration, wherein the second configuration information is a message indicating the UE to perform the L3 cell switch to a candidate cell within the set of candidate cells, and wherein applying the second configuration information based on the first configuration information to perform the L3 cell switch includes:
applying at least one of the reference configuration or a first delta configuration within the set of configurations that is associated with the candidate cell to perform the L3 cell switch to the candidate cell.

20. A method performed by a first network node, the method comprising:
determining to trigger a layer 3 (L3) cell switch for a user equipment (UE); and
transmitting configuration information related to the L3 cell switch to a second network node or to the UE.
